(19) United States
(12) Patent Application Publication
(10) Pub. No.: US 2024/0114085 A1
(43) Pub. Date: Apr. 4, 2024

(54) COORDINATION BETWEEN MEDIA END DEVICES

(71) Applicant: Bose Corporation, Framingham, MA (US)

(72) Inventors: Douglas Warren Young, Arlington, MA (US); Thomas Boilard, Chelmsford, MA (US)

(73) Assignee: Bose Corporation, Framingham, MA (US)

(21) Appl. No.: 18/475,430

(22) Filed: Sep. 27, 2023

Related U.S. Application Data
(60) Provisional application No. 63/411,206, filed on Sep. 29, 2022.

(51) Int. Cl. H04M 1/72409; G06F 3/16; H04M 1/60; H04M 1/72412

(52) U.S. Cl. CPC H04M 1/724098; G06F 3/165; H04M 1/6091; H04M 1/72412

(57) ABSTRACT

Systems and methods are presented to allow coordination between media end devices such that a user interface on a first end device may be used to manage audio calls, media playback, navigation prompts, or the like, on a second end device. The first end device establishes a first communications channel to a source device and a second communications channel to a second end device. The second end device may also have a communications channel to the source device. The first end device communicates with the second end device on the second communications channel to exchange command-and-control information to influence operation between the second end device and the source device. The source device, however, may be unaware of the second communications channel between the first and second end devices.

### CROSS-REFERENCE TO RELATED APPLICATIONS

This application claims priority to U.S. Provisional Patent Application Ser. No. 63/411,206, filed on Sep. 29, 2022, and titled “Coordination Between Media End Devices,” which application is herein incorporated by reference in its entirety.

### BACKGROUND

With the widespread adoption of connected smart devices, such as smartphones, tablets, laptops, portable speakers, headphones (wearable audio devices), smart watches, and the like, the use of multiple such devices has become ubiquitous. It is common for at least one device to be a “source” device, e.g., for media content and/or communications connections such as telephone calls (e.g., a smartphone), and multiple “sink” devices, also referred to herein as media end devices, such as a portable speaker, wearable audio (e.g., headphones, earbuds, open-ear audio devices, etc.), or a car audio system. Often a telephone call or a media playback may be routed to the “wrong” media end device (audio sink) instead of where a user wants the call or media to be routed. Accordingly, there exists a need for improved capability for a user to manage media connections among multiple end devices.

### SUMMARY

Systems and methods disclosed herein are directed to coordination between multiple media end devices to improve user functionality and user interfaces for managing media playback and telephone call functionality from a source device, such as a smartphone or other suitable device.

Generally, in one aspect, an end device is provided. The end device is a first end device. The first end device includes a first communications channel. The first communication device couples the first end device to a source device for the transfer of playback media or call audio.

The first end device further includes a second communications channel. The second communications channel couples the first end device to a second end device. The first end device communicates with the second end device on the second communications channel to exchange control information to influence operation between the second end device and the source device for the transfer of playback media or call audio between the second end device and the source device.

The second communications channel is established based upon one or more of a detected proximity between the first and second end devices, a signal strength indication, an identification of a user, a detected on-head or off-head status of one of the first or second end devices, and a wireless advertisement or beacon.

According to an example, the first end device may be one of a vehicle audio system and a wearable audio device, and the second end device may be the other of the vehicle audio system and the wearable audio device.

According to an example, the detected on-head or off-head status triggers switching playback between the first and second end devices.

According to an example, the wireless advertisement or beacon may be transmitted by one of the first end device and the second end device and received by the other of the first end device and the second end device. The first end device may be configured to automatically scan for the wireless advertisement or beacon upon start-up.

According to an example, the second end device may be associated with a user profile, and wherein the user profile corresponds to one or more indicators. The one or more indicators may include a key fob identifier and/or one or more vehicle settings.

According to an example, the second end device to form the second communications channel is selected from a plurality of end devices based on the signal strength indication.

Generally, in another aspect, a method of controlling an end device is provided. The method includes establishing, by a first end device, a communications channel to a second end device.

The method further includes exchanging control information over the communications channel to influence operation between the second end device and a source device, for the transfer of playback media or call audio between the second end device and the source device.

The communications channel or the control information is established based upon one or more of a detected proximity between the first and second end devices, a signal strength indication, an identification of a user, a detected on-head or off-head status of one of the first or second end devices, and a wireless advertisement or beacon.

According to an example, the first end device is one of a vehicle audio system and a wearable audio device, and the second end device is the other of the vehicle audio system and the wearable audio device.

According to an example, the detected on-head or off-head status triggers switching playback between the first and second end devices.

According to an example, the wireless advertisement or beacon is transmitted by one of the first end device and the second end device and received by the other of the first end device and the second end device. The first end device may be configured to automatically scan for the wireless advertisement or beacon upon start-up.

According to an example, the second end device is associated with a user profile, and wherein the user profile corresponds to one or more indicators. The one or more indicators may include a key fob identifier and/or one or more vehicle settings.

According to an example, the second end device to form the communications channel is selected from a plurality of end devices based on the signal strength indication.

Generally, in another aspect, an end device is provided. The end device is a first end device. The first end device includes a first communications channel. The first communications channel couples the first end device to a source device for the transfer of playback media or call audio.

The first end device further includes a second communications channel. The second communications channel couples the first end device to a second end device. The first end device communicates with the second end device on the second communications channel to exchange control information to influence operation between the second end device and the source device for the provision of navigation prompts between the second end device and the source device.

According to an example, the first end device is one of a vehicle audio system and a wearable audio device, and the second end device is the other of the vehicle audio system and the wearable audio device.

Generally, in another aspect, a method of controlling an end device is provided. The method includes establishing, by a first end device, a communications channel to a second end device.

The method further includes exchanging control information over the communications channel to influence operation between the second end device and a source device, for the provision of navigation prompts to the second end device.

The first end device is one of a vehicle audio system and a wearable audio device, and the second end device is the other of the vehicle audio system and the wearable audio device.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic diagram of communications channels between devices, in accordance with an example.

FIG. 2 is a schematic diagram of an example sequence of communications messages between the devices of FIG. 1.

FIG. 3 is a schematic diagram of another example sequence of communications messages between the devices of FIG. 1.

FIG. 4 is a schematic diagram of another example sequence of communications messages between the devices of FIG. 1.

FIG. 5 is a schematic diagram of a first end device, in accordance with an example.

FIG. 6 is a schematic diagram of a second end device, in accordance with an example.

FIG. 7 is a schematic diagram of a source device, in accordance with an example.

FIG. 8 is a flow chart of a method for controlling an end device, in accordance with an example.

FIG. 9 is a further flow chart of a method for controlling an end device, in accordance with an example.

### DETAILED DESCRIPTION

Systems and methods disclosed herein are directed to coordination between multiple media end devices to improve user functionality and user interfaces for managing media playback and telephone call functionality from a source device, such as a smartphone or other suitable device. The systems and methods disclosed herein solve various challenges of using multiple end devices coupled to a source device. User preferences may be stored about a preferred one of the end devices to be used to connect calls, playback media, etc., and a phone call or media may be routed to the preferred end device even when the user interacts with the other end device. In other words, systems and methods disclosed herein allow a user to use an interface on one end device to control phone calls or media playback that is routed to a second end device. For example, an automotive interface or a portable speaker interface may be used to control a call or media routed to a wearable, or vice versa.

Wearable audio devices, such as headphones, earbuds, around-the-neck or around-the-head devices, and other form factors, are typically “sinks” (accessories) that pair and connect with a mobile device, such as a smartphone or other suitable “source” device. Similarly, automotive head units or consoles, and automotive audio systems, are also typically sinks that couple (pair and connect) with a source device, which may be the same source device connected to a wearable. For example, a smartphone or other mobile or similarly capable device may simultaneously maintain a connection, such as via Bluetooth, to each of a wearable audio device and a vehicle (automotive) audio system and/or head unit. There is a desire for more integrated coordination in user control of the two sink devices (wearable and automotive), such as to be able to transfer call or media content audio or adjust volume or other functions via the interface on one of the two sink devices and have that user control input apply to the other of the two sink devices, even if the source device doesn't support, or may not even be aware of, cooperation between the two sink devices. Accordingly, there exists a need to coordinate audio experience(s) between two media end devices (sink devices).

Any suitable connection type or protocol may provide a communications channel between two end devices to allow for the exchange of command-and-control information to coordinate audio experience(s) between them. In some examples, a communications channel may be provided by classic Bluetooth or a Bluetooth Low Energy (BLE) connection.

Command-and-control information (also referred to as simply “control information” herein) exchanged between the end devices may be based upon user control inputs, e.g., such as audio routing selections, volume control, shuttle controls (e.g., play, pause, skip, back, etc.), and the like, provided on either of the end devices. For example, a user may use a volume control on an automotive system interface (e.g., a touchscreen on a head unit) to adjust volume of a phone call being taken on the user's wearable audio device. Similarly, a phone call routed through the automobile's audio system may be adjusted by a user interacting with his or her wearable audio device. For example, it may be easier for the user to reach his or her wearable audio device than to reach the automobile's head unit display.

In some examples, dashboard controls (e.g., via a touchscreen of a head unit system) may be used to switch phone audio to be provided from the phone to transfer from the head unit (automobile audio system) end device to a user wearable end device. Accordingly, the phone call audio would be re-routed from the automobile audio system to the wearable, or vice-versa.

In some examples, a wearable end device may support “on-head detection” functionality, wherein the wearable detects when it is being worn versus when it is taken off (also referred to as “don/doff” detection). In various examples, the wearable may communicate this information to another end device, such as a car audio system, and the other end device may communicate with a, e.g., smartphone, to re-route source audio (e.g., phone call or content media) from the wearable to the other end device, or vice-versa. For example, a user may be wearing a wearable end device and participating in a phone call via the wearable end device, but wants to transfer the call audio to an automobile audio system (the other end device). The user may simply remove the wearable, and the wearable may communicate to the automobile audio system that it is no longer “on-head,” in response to which the automobile audio system may instruct the smartphone to switch the audio to the automobile end device as the active audio end device. The reverse may also be supported, e.g., putting on the wearable may trigger the “on-head” detection and coordination between the end devices, leading to the smartphone causing the call audio to switch to the wearable as the active audio end device.

In various examples, various methods of pairing and/or connecting or coupling the end devices to establish a communications channel for command-and-control information exchange may be supported. In some examples, wireless advertisements or beacon signals (such as BLE advertisements) from either end device may be detected by the other end device to determine the presence of the first end device and may be configured to pair automatically to the first end device. In some examples one or more end devices may detect proximity to another end device, such as by a received signal strength indicator (RSSI), and may pair or connect to the closest end device. Certain examples may support “fast pairing” such as may be provided by Google, e.g., the Google Fast Pair proprietary standard, to facilitate paring and connection.

Conventional car/automotive audio systems do not perform the types of pairing and connecting, e.g., with other end devices, as described above because such audio system have conventionally been “sink” devices only and are not configured to be a primary device in a, e.g., Bluetooth, relationship with other devices. According to various examples herein, however, a car audio system (or any other media end device) may act as a “source” in that it may listen for or discover and pair or connect with other end devices, contrary to conventional end devices.

In various examples, when an end device is powered on (e.g., starting a car will start the head unit and associated audio system) the end device may wirelessly scan for nearby end devices, such as by BLE advertisements, to detect nearby paired wearable end devices in range and decide whether to connect to the wearable end device. In some cases, if more than one paired wearable is in range, a signal strength indication may be evaluated to connect to the closest wearable audio device. In some examples, the wearable audio device to which the automobile end device connects may be associated with a particular user and a particular set of stored preferences associated with that user may be selected. In certain examples, users and their preferences may be associated with other indicators of who the user is, such as an identity of a key fob or selection of a user settings button for, e.g., seat location and orientation, mirror orientations, HVAC settings, and the like.

Audio Routing Management

In some examples, the systems and methods described herein may be used to manage audio routing. For example, the audio being routed may include vehicle navigation announcements, navigation prompts, or other information regarding vehicle navigation. The source of the navigation announcements may be a source device, such as a smartphone or a portable navigation device, such as a navigation device utilizing Global Positioning System (GPS) data. In a typical configuration, the audio navigation announcements are provided to a driver via the vehicle head unit. The announcements may be transmitted from the source device to the head unit according to the advanced audio distribution profile (A2DP) standard. However, a communications channel between the head unit and a wearable audio device may be used to negotiate which device receives the navigation announcements from the source device. Thus, a driver may be able to listen to the navigation announcements on their wearable rather than the head unit of the vehicle audio system. Proprietary communications protocols and command formats may be used for communication between the head unit and the wearable. In other examples, a third-party communication interface like Google Fast Pair or Google Smart Audio Source Switching may be used. Future Bluetooth low energy (LE) Audio Profiles such as the Routing Active Audio Profile may be used to facilitate this communication.

Further Extensions of Audio Routing and Configuration

A wide array of extensions of the systems and methods are possible. In some examples, the audio routing may be facilitated by a mobile application of the smartphone or a user interface of the head unit. From these applications or interfaces, the user may be able to (1) transfer the audio provided by the smartphone to the head unit or wearable, (2) control aspects of the audio being played back, and/or (3) provide desired settings or user preferences regarding the audio routing (such as automatically routing audio to the wearable audio device when worn).

In some examples, the head unit may include a toggle-like feature automatically routing the audio based on the if the wearable is on-head (don) or off-head (doff). For example, if the “on-head”status of the wearable audio device is don, then the audio may be automatically routed to the wearable audio device. Similarly, if the “on-head” status of the wearable audio device is doff, then the audio may be automatically routed to the head unit. This feature may be toggled (activated or deactivated) according to user input received by the user interface of the head unit.

In some examples, the audio from the source device may be routed according to one or more user settings of a user profile. For example, the user setting may define a “preferred” wearable audio device out of a plurality of wearable audio devices. For example, while a user may use several types of wearable audio devices (headphones, earbuds, etc.), the user may prefer a particular wearable audio device while operating a vehicle.

In some examples, if the user pairs the head unit with the wearable audio device, the wearable audio device may be associated or linked with the aforementioned user profile. Further, the user profile may be associated or linked one or more indicators of user identity, such a key fob identifier or vehicle settings (such as preferred seat settings). Thus, if the user enters the vehicle with a known key fob, the head unit may be able to automatically retrieve the user profile associated with the key fob. The settings of the user profile may then be used to form a communications channel between the head unit and the previously paired wearable audio device. The head unit may store several different user profiles.

In some examples, the settings of one user profile may be assigned (manually or automatically) to another user profile. Accordingly, the preferred wearable audio device of one user profile may then be assigned to be the preferred wearable audio of another user profile as well.

In some examples, following the association wearable audio device with a user profile, detection of a user indicator (such the key fob) associated with the user profile may automatically trigger the establishment of the communications channel between the wearable audio device and the head unit.

In some examples, the wearable audio device may communicate safety data to the head unit whether the particular wearable audio device is safe to use while operating a vehicle. For example, open ear wearables are typically considered to be safe to use during vehicle operation, while closed ear wearables are typically considered to be unsafe if both ears are occluded. Accordingly, wearables that only occlude one ear, such as a single earbud, may be safe to use as long as the other ear is not occluded. This safety data may be used to prevent audio from the source device from being routed to the wearable audio device during vehicle operation. Alternatively, this safety data may trigger the head unit or other aspects of the vehicle to inform the user of unsafe usage of the wearable audio device, such as through audio and/or visual notifications. The safety data may also reflect and/or incorporate legal information regarding legal or illegal use of the wearable audio device.

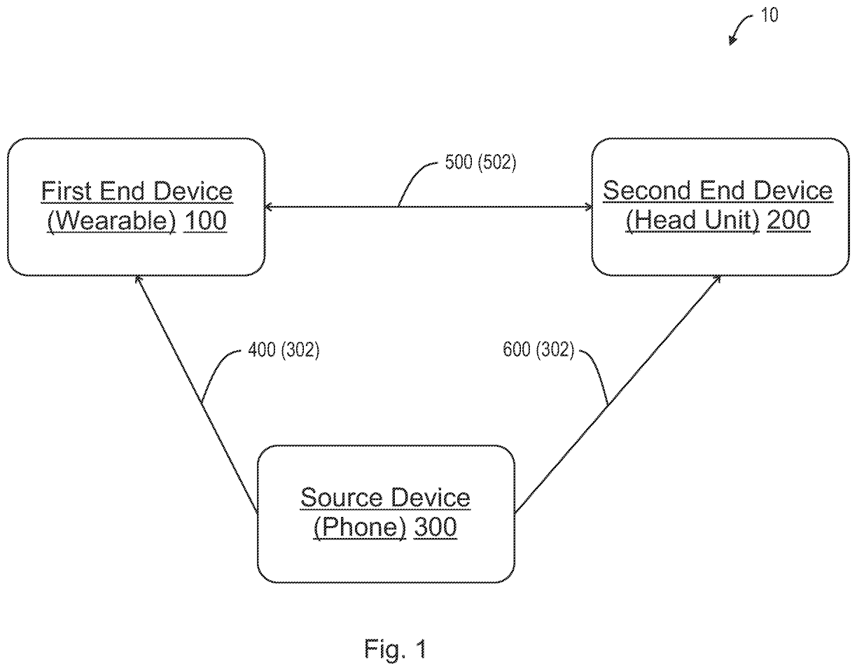

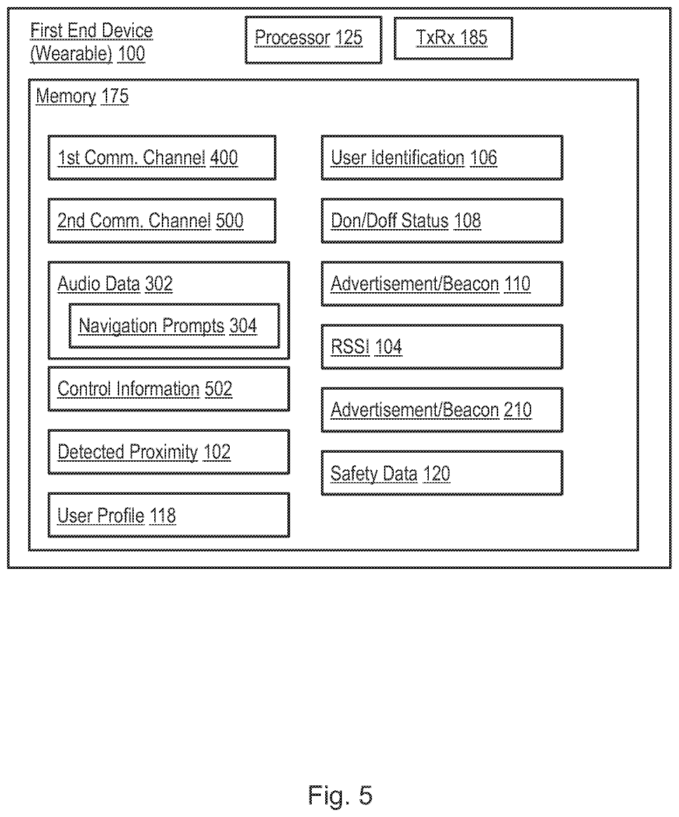

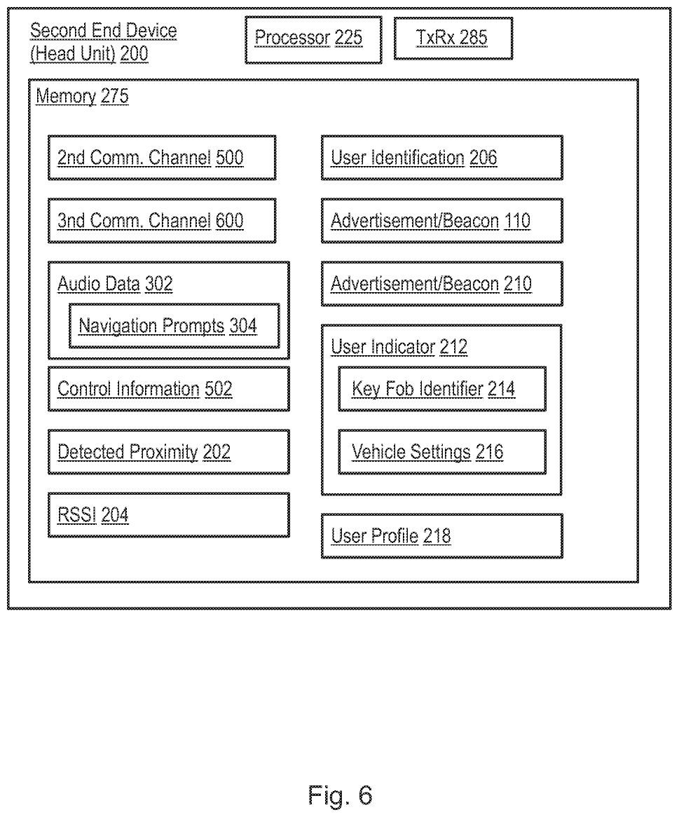

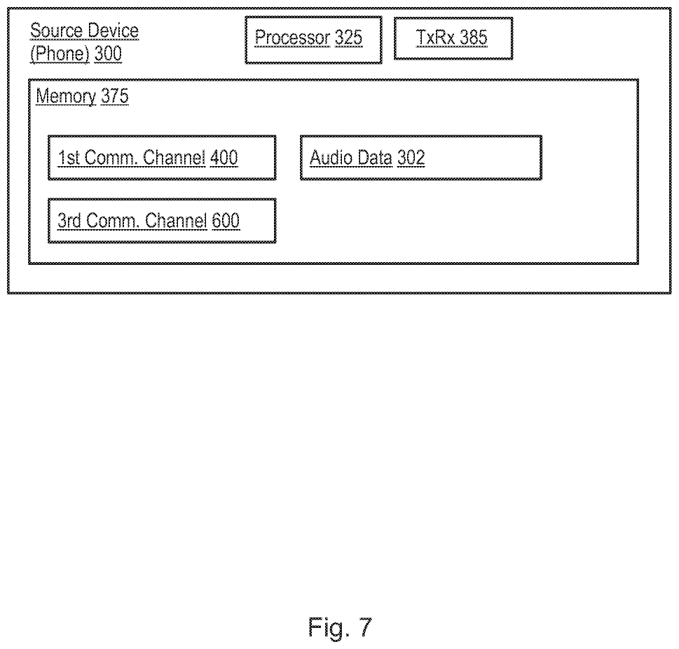

The following description should be read in view of FIGS. 1-9. FIG. 1 is a schematic view of components of a system 10 according to the present disclosure. In the non-limiting example of FIG. 1, the system 10 includes at least a first end device 100, a second end device 200, and a source device 300. As illustrated, the first end device 100 may be a wearable audio device, such as a set of audio headphones, an audio headset, a pair of earbuds, a set of audio eyeglasses, a set of hearing aids, etc. Aspects of the first end device 100 are shown in more detail in FIG. 5. The second end device 200 may be a head unit for a vehicle audio system. Aspects of the second end device 200 are shown in more detail in FIG. 6. The source device 300 may be a smartphone or mobile device. Aspects of the source device 300 are shown in more detail in FIG. 7. In other examples, the first end device 100 may instead be the head unit, while the second end device 200 may be the wearable audio device. In other examples, the second end device 200 could be a discrete speaker, such as a speaker which is a component of a home audio system. More generally, the source device 300 is considered an audio source for wirelessly, such as via Bluetooth connection, providing audio data to sink devices (the first and second end devices 100, 200) for audio playback. Thus, the first end device 100, the second end device 200, and the source device 300 are all configured to wirelessly transmit and receive data, which may include audio data 302 and/or control information 502, to and from the other components of the system 10. Further, in some examples, the first and/or second end devices 100, 200 may include a user interface to control operation of the other device 100, 200. The user interface may be embodied as a touch screen, one or more physical or virtual buttons, a keypad, etc.

FIG. 1 further illustrates three communications channels 400, 500, 600 between the three devices 100, 200, 300. In particular, the first communications channel 400 wirelessly connects the source device 300 to the first end device 100. The second communications channel 500 connects the first end device 100 to the second end device 200. The third communications channel 600 connects the source device 300 to the second end device 200.

Conventional systems typically include the first and third communications channels 400, 600 to enable the source device 300 to provide audio data 302 to the first and second end devices 100, 200. These communications channels 400, 600 may use a Hands-Free Profile (HFP) or Handset Profile (HSP) to convey the audio data 302. The audio data 302 may include telephone call audio or other types of audio generated by the source device 300, such as music, navigation prompts, etc. The first and third communications channels 400, 600 may be formed using aspects of the Bluetooth standard, such as Bluetooth classic or LE Audio. In some examples, the audio data 302 may be provided according to the A2DP standard.

The system 10 of FIG. 1 further includes a second communications channel 500. The second communications channel 500 may be considered a “back channel” to enable the first end device 100 and the second end device 200 to exchange command-and-control information 502 (also referred to as “control information”) without going through the source device 300. Conventionally, if the user wanted to use the second end device 200 to control the operation between the first end device 100 and the source device 300, the source device 300 would need to support this functionality. Accordingly, the back channel enables this control and coordination without the involvement of the source device 300.

The second communications channel 500 may use any suitable communication standard or protocols to exchange command-and-control information 502 between the end devices 100, 200. In some examples, the second communications channel 500 may be a unidirectional or bidirectional Bluetooth Low Energy (BEL) connection. In further examples, this connection may implement a BMAP protocol to exchange command-and-control information 502, a proprietary protocol of the Bose Corporation.

Accordingly, the system 10 shown in FIG. 1 enables a user to route audio (telephone call, music, navigation, etc.) to their preferred end device 100, 200 without interacting with the source device 300. For example, the user may utilize a user interface of the second end device 200 to transfer the audio of a telephone call to the first end device 100. Further, the user may then remove the wearable first audio device 100 from their head to transfer the audio back to the second end device 200. Any preferences gleaned from these interactions may be stored in a user profile 118 stored by the wearable audio device 100 or a user profile 218 stored by the head unit 200.

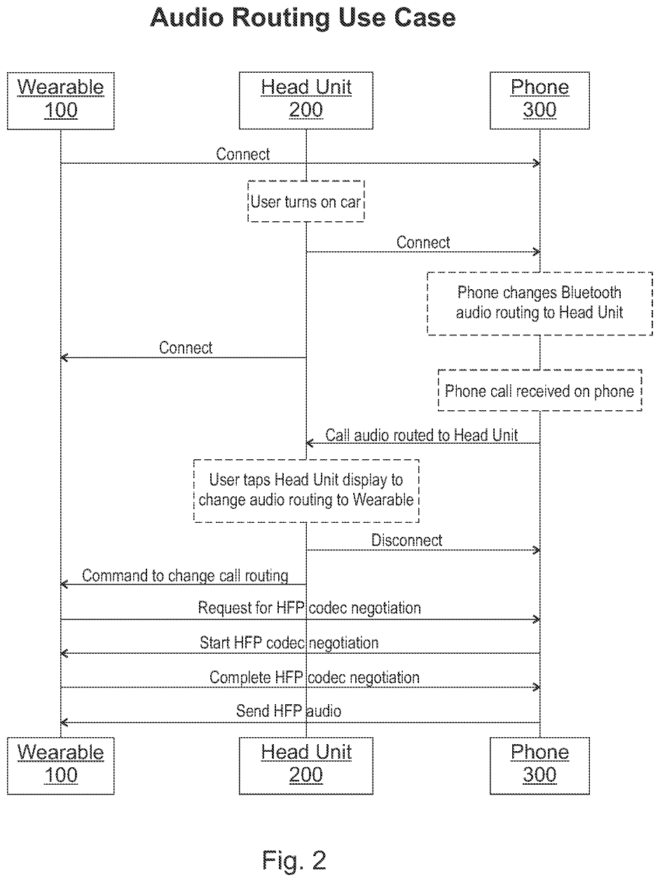

FIG. 2 is a schematic diagram of an example sequence of communications messages between the devices 100, 200, 300 of the system 10 illustrated in FIG. 1. In particular, FIG. 2 describes routing audio in a vehicular environment between a wearable audio device 100 (such as a non-occluding earbud), a head unit 200 of a vehicle audio system, and a smartphone 300. As shown in FIG. 2, the wearable audio device 100 wirelessly connects to the phone 300 to form the first communications channel 400 shown in FIG. 1. As previously described, the first communications channel 400 may convey audio data from the phone 300 to the wearable audio device 100 via HFP or HSP. The head unit 200 of the vehicle audio system then connects to the phone 300 once the vehicle is turned on.

Once the vehicle is turned on, the phone 300 then adjusts the routing of Bluetooth audio data to be received by the head unit 200, rather than the wearable audio device 100 or another device. This routing may be configured according to a previously programmed user setting. Further, the head unit 200 connects to the phone 300 to form the third communications channel 600 shown in FIG. 1. As previously described, the third communications channel 600 may convey audio data from the phone 300 to the head unit 200 via HFP or HSP. Additionally, the head unit 200 connects to the wearable audio device 100 to form the second communications channel 500. As previously described, the second communications channel 500 acts as a “back channel” to enable the first end device 100 and the second end device 200 to exchange command-and-control information 502 without going through the source device 300.

Returning to FIG. 2, the phone 300 then receives a phone call. Per the initial configuration of the system 10, the phone call audio is routed to the head unit 200 for playback. Thus, the call audio will be played via the head unit 200 and other aspects of the vehicle audio system. In many situations, playing the audio via the head unit 200 results in the call audio being audible to the driver and any passengers of the vehicle. However, in some cases, the driver may wish for more privacy regarding the phone call, and choose, as shown in FIG. 2, to route the call audio to the wearable audio device 100 by tapping a user interface of the head unit 200.

The head unit 200 communicates with both the wearable audio device 100 and the phone 300 individually to facilitate the routing of the call audio to the wearable audio device 100. In particular, the head unit 200 first disconnects the third communications channel 600 to the wearable audio device 100. The head unit 200 then transmits, via the second communications channel 500, command-and-control information 502 to the wearable audio device 100 to trigger the wearable audio device 100 to request and receive the call audio from the phone 300. As shown in FIG. 2, the wearable audio device 100 requests HFP codec negotiation with the phone 300 upon receiving the command-and-control information 502. Following successful HFP codec negotiations, the HFP audio is then transmitted from the phone 300 to the wearable audio device 100, thereby successfully routing call audio.

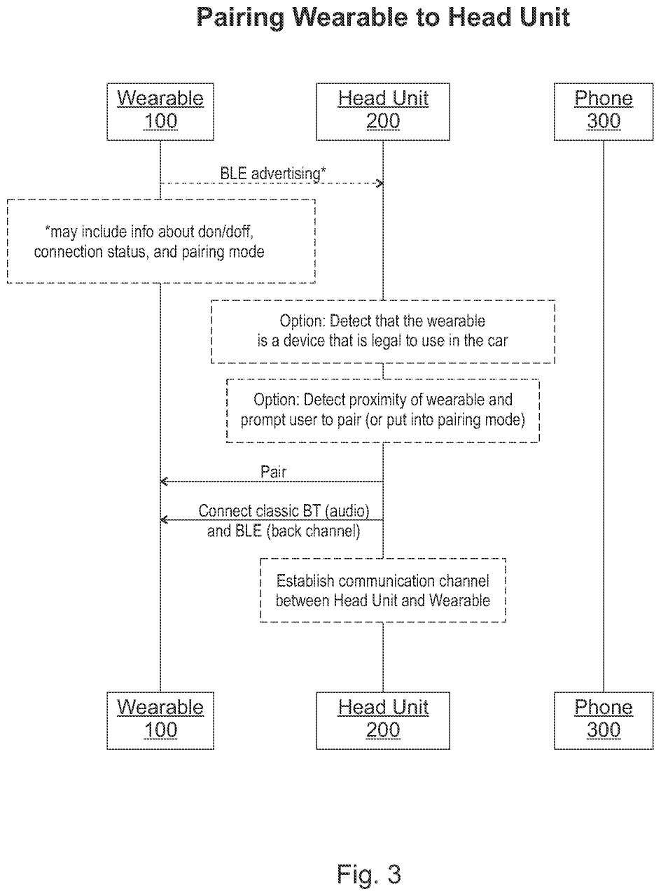

FIG. 3 is a schematic diagram of another example sequence of communications messages between the devices 100, 200, 300 of the system 10 illustrated in FIG. 1. In the example of FIG. 3, information is exchanged to pair the wearable audio device 100 to the head unit 200. As shown in FIG. 3, the wearable audio device 100 transmits advertisements 110 (in particular, BLE advertising data) which are received by the head unit 200. The advertisements 110 may include a variety of information, such as on-head (don) or off-head (doff) status 108 of the wearable audio device 100, status information regarding prior pairing involving the wearable audio device 100, and information regarding particular pairing modes (such as Google Fast Pair). Upon receiving the advertisements 110, the head unit 200 may be able to determine additional information, such as detecting if the wearable audio device 100 is safe and/or legal to be worn while operating a vehicle. Similarly, the head unit may also be able to determine proximity of the wearable audio device 100 to the head unit 200 and either initiate pairing or prompt the user to pair the wearable audio device 100 to the head unit 200 based on the determined proximity (such as if the wearable audio device 100 is sufficiently close to the head unit). The head unit 200 may then pair to the wearable audio device 100 to form two wireless connections: (1) a Bluetooth classic connection with the phone 300 to convey audio from the head unit 200 to the wearable audio device 100 and (2) a BLE connection with the head unit 200 to exchange command-and-configuration data between the wearable audio device 100 and the head unit 200.

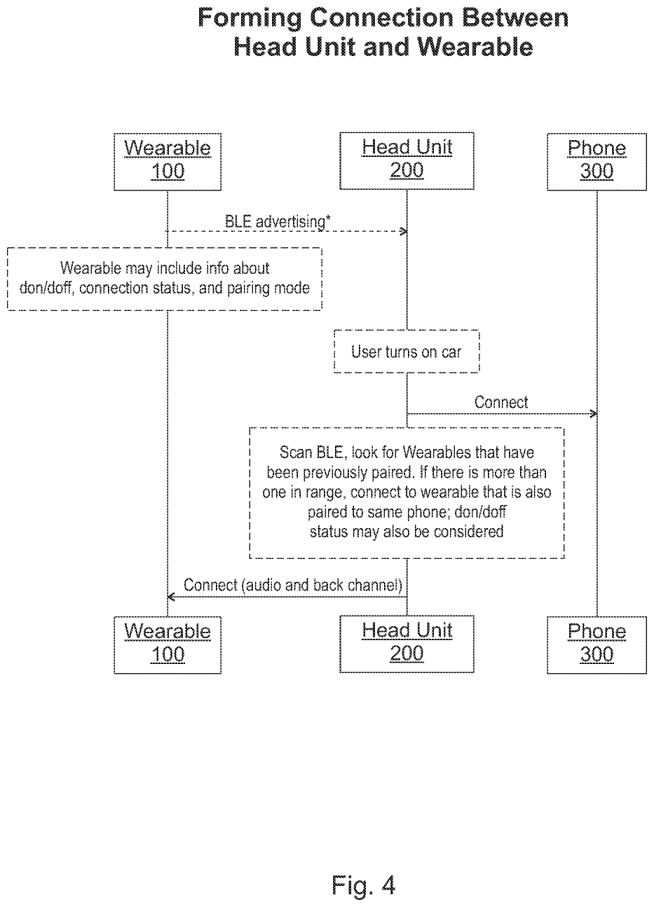

FIG. 4 is a schematic diagram of another example sequence of communications messages between the devices 100, 200, 300 of the system 10 illustrated in FIG. 1. In the example of FIG. 4, information is exchanged to form connections between the wearable audio device 100 to the head unit 200. As with the example of FIG. 3, the wearable audio device 100 transmits advertisements 110. As the vehicle is initially turned off, the head unit 200 is not able to immediately receive the advertisements 110. The vehicle is then turned on, and the head unit 200 connects to the phone 300. The head unit 200 also scans for advertisements 110 for previously paired wireless audio devices 100. If the head unit 200 is positioned to receive advertisements 110 from multiple wearable audio devices 100, the head unit may select one of the multiple wearable audio device 100 based on whether the wearable audio device 100 was previously connected to the head unit, as well as the don/doff status 108 of the wearable audio device 100. The head unit 200 then triggers the wearable audio device 100 to form a Bluetooth classic connection to convey audio from the phone 300 to the wearable audio device 100 and a BLE connection to exchange command-and-configuration data between the wearable audio device 100 and the head unit 200. In some examples, the audio is transmitted over the Bluetooth classic connection according to the A2DP standard.

FIG. 5 schematically illustrates the first end device 100 previously depicted in FIGS. 1-4. The first end device 100 may be a wearable audio device as shown in FIGS. 1-4. As shown in the non-limiting example of FIG. 5, the first end device 100 may include a processor 125, a memory 175, and a transceiver 185. The memory 175 may store data facilitating the first communications channel 400 (connecting the first end device 100 to the source device 300 to convey the audio data 302) and the second communications channel 500 (connecting the first end device 100 to the second end device 200 to convey the command-and-control information 502). The memory 175 may further be configured to store detected proximity data 102, RSSI data 104, user identification data 106, don/doff status data 108, advertisements or beacons 110 to be transmitted by the first end device 100, user profile data 118, wearable safety data 120. The memory 175 may further store advertisements or beacons 210 and/or command-and-control information 502 transmitted by the second end device 200. The memory 175 may further include audio data 302 transmitted by the source device 300. The transceiver 185 may be configured to facilitate wireless communication between the first end device 100 and the second end device 200 and/or the source device 300.

FIG. 6 schematically illustrates the second end device 200 previously depicted in FIGS. 1-4. The second end device 200 may be a head unit of a vehicle audio system as shown in FIGS. 1-4. As shown in the non-limiting example of FIG. 6, the second end device 200 may include a processor 225, a memory 275, and a transceiver 285. The memory 275 may store data facilitating the second communications channel 500 (connecting the first end device 100 to the second end device 200 to convey the command-and-control information 502) and the third communications channel 600 (connecting the second end device 200 to the source device 300 to convey the audio data 302). The memory 275 may further be configured to store detected proximity data 202, RSSI data 204, user identification data 206, advertisements or beacons 210 to be transmitted by the second end device 200, user indicators 212 (including a key fob identifier 214 and/or vehicle settings 216), and user profile data 218. The memory 275 may further store advertisements or beacons 110 and/or command-and-control information 502 transmitted by the first end device 100. The memory 275 may further include audio data 302 transmitted by the source device 300. The transceiver 285 may be configured to facilitate wireless communication between the second end device 200 and the first end device 100 and/or the source device 300.

FIG. 7 schematically illustrates the source device 300 previously depicted in FIGS. 1-4. The source device 300 may be a smartphone as shown in FIGS. 1-4. As shown in the non-limiting example of FIG. 7, the source device 300 may include a processor 325, a memory 375, and a transceiver 385. The memory 375 may store data facilitating the first communications channel 400 (connecting the first end device 100 to the source device 300 to convey the audio data 302) and the third communications channel 600 (connecting the second end device 200 to the source device 300 to convey the audio data 302). As described above, the source device does not transmit or receive data to configure routing of audio (such as phone call audio or navigation audio) to the first or second end devices 100, 200. The transceiver 385 may be configured to facilitate wireless communication between the source device 300 and the first end device 100 and/or the second end device 200.

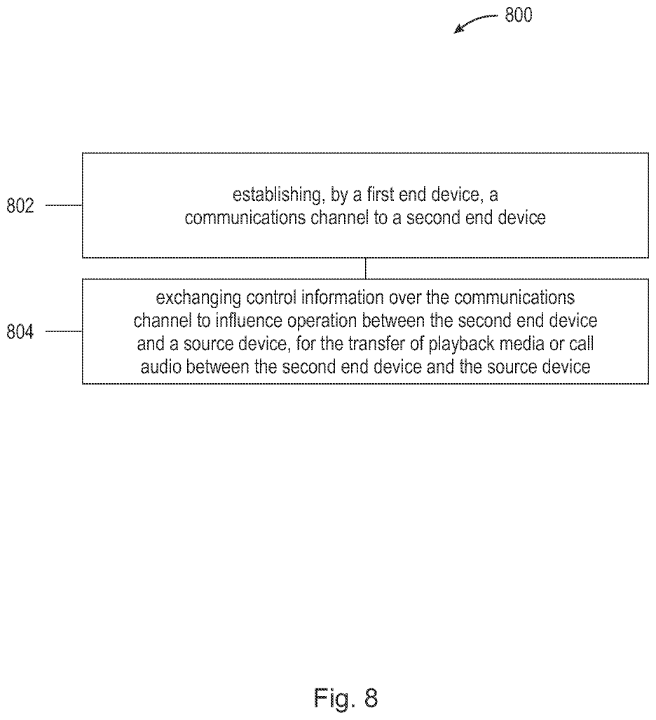

FIG. 8 is a flow chart of a method 800 of controlling an end device. Referring to FIGS. 1-9, the method 900 includes, in step 802, establishing, by a first end device 100, a communications channel 500 to a second end device 200. The method 800 further includes, in step 804, exchanging control information 502 over the communications channel to influence operation between the second end device 200 and a source device 300, for the transfer of playback media or call audio 302 between the second end device 200 and the source device 300. The communications channel 500 or the control information 502 is established based upon one or more of a detected proximity 102 between the first and second end devices 100, 200, a signal strength indication 104, an identification 106 of a user, a detected on-head or off-head status 108 of one of the first or second end devices 100, 200, and a wireless advertisement or beacon 110.

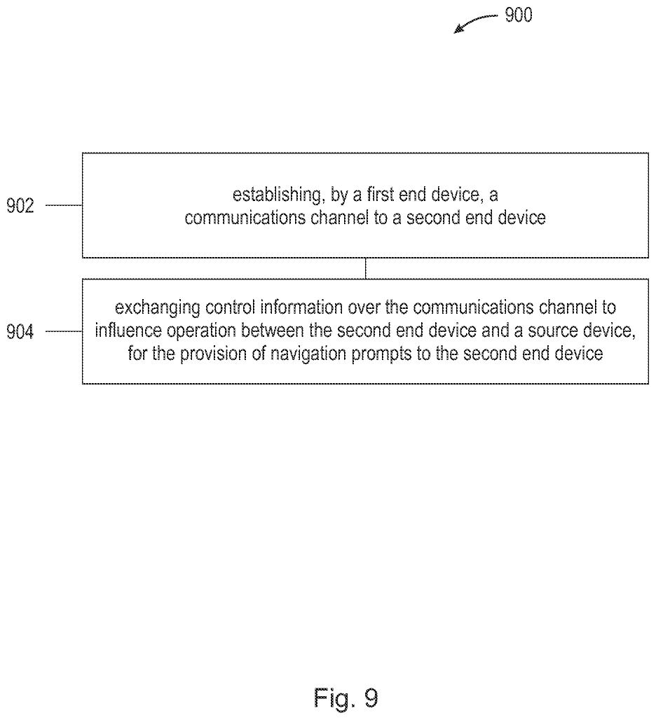

FIG. 9 is a flow chart of a further method 900 of controlling an end device. Referring to FIGS. 1-9, the method 900 includes, in step 902, establishing, by a first end device 100, a communications channel 500 to a second end device 200. The method 900 further includes, in step 904, exchanging control information 502 over the communications channel 500 to influence operation between the second end device 200 and a source device 300, for the provision of navigation prompts 304 to the second end device 200.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. An end device that is a first end device, comprising:
a first communications channel for coupling to a source device for the transfer of playback media or call audio; and
a second communications channel for coupling to a second end device, wherein the first end device communicates with the second end device on the second communications channel to exchange control information to influence operation between the second end device and the source device for the transfer of playback media or call audio between the second end device and the source device,
wherein the second communications channel is established based upon one or more of a detected proximity between the first and second end devices, a signal strength indication, an identification of a user, a detected on-head or off-head status of one of the first or second end devices, and a wireless advertisement or beacon.

2. The end device of claim 1, wherein the first end device is one of a vehicle audio system and a wearable audio device, and the second end device is the other of the vehicle audio system and the wearable audio device.

3. The end device of claim 1, wherein the detected on-head or off-head status triggers switching playback between the first and second end devices.

4. The end device of claim 1, wherein the wireless advertisement or beacon is transmitted by one of the first end device and the second end device and received by the other of the first end device and the second end device.

5. The end device of claim 4, wherein the first end device is configured to automatically scan for the wireless advertisement or beacon upon start-up.

6. The end device of claim 1, wherein the second end device is associated with a user profile, and wherein the user profile corresponds to one or more indicators.

7. The end device of claim 6, wherein the one or more indicators include a key fob identifier and/or one or more vehicle settings.

8. The end device of claim 1, wherein the second end device to form the second communications channel is selected from a plurality of end devices based on the signal strength indication.

9. A method of controlling an end device, the method comprising:
establishing, by a first end device, a communications channel to a second end device; and
exchanging control information over the communications channel to influence operation between the second end device and a source device, for the transfer of playback media or call audio between the second end device and the source device,
wherein the communications channel or the control information is established based upon one or more of a detected proximity between the first and second end devices, a signal strength indication, an identification of a user, a detected on-head or off-head status of one of the first or second end devices, and a wireless advertisement or beacon.

10. The method of claim 9, wherein the first end device is one of a vehicle audio system and a wearable audio device, and the second end device is the other of the vehicle audio system and the wearable audio device.

11. The method of claim 9, wherein the detected on-head or off-head status triggers switching playback between the first and second end devices.

12. The method of claim 9, wherein the wireless advertisement or beacon is transmitted by one of the first end device and the second end device and received by the other of the first end device and the second end device.

13. The method of claim 12, wherein the first end device is configured to automatically scan for the wireless advertisement or beacon upon start-up.

14. The method of claim 9, wherein the second end device is associated with a user profile, and wherein the user profile corresponds to one or more indicators.

15. The method of claim 14, wherein the one or more indicators include a key fob identifier and/or one or more vehicle settings.

16. The method of claim 9, wherein the second end device to form the communications channel is selected from a plurality of end devices based on the signal strength indication.

17. An end device that is a first end device, comprising:
a first communications channel for coupling to a source device for the transfer of playback media or call audio; and
a second communications channel for coupling to a second end device, wherein the first end device communicates with the second end device on the second communications channel to exchange control information to influence operation between the second end device and the source device for the provision of navigation prompts between the second end device and the source device.

18. The end device of claim 17, wherein the first end device is one of a vehicle audio system and a wearable audio device, and the second end device is the other of the vehicle audio system and the wearable audio device.

19. A method of controlling an end device, the method comprising:
establishing, by a first end device, a communications channel to a second end device; and
exchanging control information over the communications channel to influence operation between the second end device and a source device, for the provision of navigation prompts to the second end device.

20. The method of claim 19, wherein the first end device is one of a vehicle audio system and a wearable audio device, and the second end device is the other of the vehicle audio system and the wearable audio device.
